(19) United States
(12) Patent Application Publication
(10) Pub. No.: US 2003/0218754 A1
(43) Pub. Date: Nov. 27, 2003

(54) Apparatus and method for depositing optical thin film

(75) Inventor: Yuichi Umeda, Miyagi-ken (JP)

Correspondence Address: BEYER WEAVER & THOMAS LLP, P.O. BOX 778, BERKELEY, CA, 94704-0778, US

(73) Assignee: ALPS ELECTRIC CO., LTD.

(21) Appl. No.: 10/441,509

(22) Filed: May 19, 2003

(30) Foreign Application Priority Data
May 24, 2002 (JP) 2002-151279

(51) Int. Cl. G01B 9/02

(52) U.S. Cl. 356/485

(57) ABSTRACT

A film deposition apparatus includes an optical monitor for measuring the light intensities of a plurality of measuring light beams having different wavelengths that are transmitted or reflected by a film during deposition, a phase estimating section for calculating the phase of a point corresponding to a desired film thickness for each of the measuring wavelengths based on the relationship between the expected periodic change in the light intensity of the corresponding measuring light beam until the desired thickness is reached, and the phase corresponding to the periodic change, and calculating the degree of phase advance by comparing the periodic change and the change in the intensity monitored by the optical monitor, and a deposition control unit for comprehensively determining a deposition end point based on all the degrees of phase advance and for completing the film deposition at the deposition end point.

### BACKGROUND OF THE INVENTION

1. Field of the Invention

The present invention relates to an optical-thin-film deposition method and an apparatus for precisely forming on a substrate a multilayer thin film for use in optical devices.

2. Description of the Related Art

In recent years, optical communication using optical fiber has become popular. Accompanying this rise in popularity has been an increasing demand to enhance the performance of optical devices used as various filters for optical communication, that is, to achieve high-precision optical characteristics.

To achieve these goals, it its important to form a multilayer thin film for use in the optical devices by stacking multiple optical thin films of the multilayer thin film on the surface of a substrate while precisely controlling the thicknesses of the layers.

In one conventional method, an IBS (Ion Beam Sputtering) apparatus such as shown in FIG. 16 is used to provide high-precision thickness control in forming layers that constitute the optical thin film.

In the IBS apparatus, thin-film materials provided in a target inside an apparatus body 100 are heated and evaporated by energy generated by the shock of an ion beam emitted from an ion gun 102. The ion gun 102 is under the control of a deposition control unit 103, and thin films are formed by plasma-state molecules of these thin materials. Therefore, the density of the formed films is high. Moreover, since film stacking is performed in a high vacuum, few impurities are mixed in the thin films, and high-quality thin films can be stacked precisely.

In the IBS sputtering apparatus, a film thickness sensor (hereinafter referred to as an “optical monitor”) for measuring the transmittance (or reflectance) of a thin film formed on the substrate is used as a film thickness monitor 101. By measuring the transmittance (or reflectance) the thickness of the film in the apparatus body 100 is determined. With this optical monitor, multiple thin films having designed thicknesses are produced while controlling the thickness of each of the thin films formed on the substrate.

In the optical monitor, as the thickness of a thin film changes (increases) during deposition, the transmittance (or reflectance) periodically changes. The peak value or bottom value of the transmittance (or reflectance) is observed whenever a predetermined optical thickness (i.e., a thickness equal to an integral multiple of λ/4 of the wavelength of measuring light) that is expressed by the product of the physical thickness of the film and the refractive index is attained.

In the conventional optical monitor, the peak value or bottom value (hereinafter, both the values will be generically referred to “extreme values”) is detected and used as a criterion for controlling the film thickness (hereinafter, the film thickness means an optical thickness) during deposition.

The optical monitor can directly measure the optical thickness (dₚ=n·d) including a change in refractive index (n)

That is, the optical monitor selects the wavelength λ of measuring light for each layer so that the film thickness dₚ of the layer is equal to an integral multiple of λ/4 of the wavelength λ of the measuring light, subjects the measuring light to signal processing, and thereby measures a secular change in transmittance or the like (periodic phase change in transmittance) shown in FIG. 17.

Once the transmittance reaches the extreme value (for example, time t1, t2), the deposition control unit 103 detects that a thin film having the necessary thickness dₚ is completed, and stops the operation of the ion gun 102 to terminate deposition of the thin film in the apparatus body 100.

In the conventional optical monitor, frequently, a laser light source or the like is used as a light source for measuring light, and the film thickness is measured with monochromatic measuring light.

In some optical monitors, light with a predetermined wavelength to be used as measuring light is derived from a broadband white light source by a spectroscopic means such as a diffraction grating.

Both of the above two measuring methods select the measuring wavelength so that the detected peak value of transmittance for a predetermined thin film to be deposited is the point at which the film deposition is terminated.

However, the above-described conventional optical monitors provide several disadvantages in use as film-thickness monitors for precisely formed multilayer thin films.

Since the film deposition is terminated in response to the detection of the extreme value of transmittance by the optical monitor, additional operations are performed to determine the deposition end point from the transmittance values measured within a limited range adjacent to the extreme value of an approximate curve representing changes in transmittance with time. For example, the additional operations may include an estimation of the time at which the extreme value is obtained, or estimation of the time that has elapsed from the extreme value corresponding to a predetermined film thickness. Unfortunately, small variations in transmittance due to disturbances, the interference of measuring light in the glass substrate, or similar causes increase the errors in calculating the time at which the extreme values will be reached or estimating the time from an extreme value to a predetermined film thickness. That is, the approximate curve for estimation deforms. This makes it difficult to precisely control the film deposition.

Furthermore, if the extreme value of the transmittance is used as a criterion for controlling the film deposition, it is always necessary to detect the extreme value of the transmittance of each of the layers that constitute a multilayer film. But the film thickness of each layer must exceed λ/4 of the wavelength λ of the measuring light.

Therefore, when a multilayer optical filter is designed and produced, there is a need to adjust the film thickness of each layer so that the thickness exceeds λ/4 of the wavelength λ of the measuring light in the conventional optical monitors. Hence, a thicker film must sometimes be formed to obtain the extreme value of the transmittance, although a thin film can be formed by reducing the film thickness to λ/4 or less. The above described limitation extends the production time of the entire filter, decreases production efficiency significantly, and increases production cost.

Multilayer optical filters, such as a gain flattening filter (GFF), that are required to have a transmittance characteristic for light with a broadband wavelength, may deviate from design values even when the film thickness of a predetermined layer is precisely controlled with monochromatic measuring light. For example, when the film thickness of a previously formed layer deviates from its designed thickness due to a deposition error, the deposition error is compensated by the thickness of the predetermined layer. In this case, the optical thickness of the predetermined layer thereby deviates from the designed value, and the film thickness of the previously formed layer also has an error with respect to the designed value.

In addition, when measuring light other than the predetermined monochromatic light is used, that is, when the measuring wavelength is changed according to the layers, any disturbance or deviation in any of the measuring wavelengths causes an error in the film thickness of the corresponding layer. Hence, as subsequent layers are sequentially deposited, the above deviation causes transmittance errors to accumulate, and distorts approximation curves that show changes in transmittance of the layers estimated from the measured transmittances. The resulting decrease in accuracy in estimating the deposition end point of each layer prevents optimum film deposition control, limits the accuracy in depositing the layers of the multilayer film, and increases error in wavelength characteristics (spectral characteristics) of the multilayer filter.

### SUMMARY OF THE INVENTION

The present invention has been made in such a background, and an object of the present invention is to provide an optical-thin-film deposition method and apparatus which can control the deposition of a thin film having a thickness corresponding to λ/4 or less of a measuring wavelength that cannot be easily controlled by a conventional optical monitor, and which can control the deposition of each layer of a multilayer film with high precision.

In order to achieve the above object, according to one aspect, the present invention provides an optical-thin-film deposition apparatus including an optical measurement means (optical monitor 11), a phase estimating means (phase estimating section 12) and a deposition control means (deposition control unit 13), each of the functions of the optical measurement means, phase estimating means, and deposition control means being further described below. That is, the deposition apparatus includes an optical measurement means (optical monitor 11) for measuring the light intensities of a plurality of measuring light beams having different wavelengths that are transmitted or reflected by a film during deposition. The deposition apparatus also includes a phase estimating means (phase estimating section 12) for calculating the phase of a point corresponding to a desired film thickness for each of the measuring wavelengths based on the relationship between the expected periodic change in the light intensity of the corresponding measuring light beam until the desired film thickness is reached, and the phase corresponding to the periodic change, and calculating the degree of phase advance by comparing the periodic change and the change in the light intensity of the measuring light beam monitored by the optical measurement means, the degree of phase advance representing the ratio of the phase of a point corresponding to the thickness of the film during deposition to the phase of the point corresponding to the desired film thickness. Further, the deposition apparatus also includes a deposition control means (deposition control unit 13) for comprehensively determining a deposition end point based on the degrees of phase advance for all the wavelengths and for completing the film deposition at the deposition end point.

The phases of changes in light intensity corresponding to the deposition end point are not found with monochromatic light, but with a plurality of measuring light beams having different wavelengths, and the phases are compared with target phases corresponding to the respective measuring wavelengths (i.e., phases at the deposition end points corresponding to the measuring wavelengths). Thereby, the influence of disturbance in one wavelength is reduced, and the deposition end point is found more precisely than when estimation is formed with only monochromatic light (i.e., estimation accuracy is increased). This can reduce error in each layer and can enhance the wavelength characteristics (spectral characteristics) of the multilayer filter.

In the optical-thin-film deposition apparatus of the present invention, even when the measured transmittance fluctuates because of disturbance or the like, the deposition end point is comprehensively determined by the degrees of phase advance corresponding to the measuring light beams on the basis of phase changes found on approximation curves (cosine or sinusoidal function based on the reciprocal of the transmittance) corresponding to the wavelengths fitted by the measured transmittances of all the measuring light beams (light intensity of transmitted light). Therefore, the accuracy in estimating the deposition end point for each layer can be increased, and improved noise resistant of the control is possible than when the film thickness is controlled with monochromatic light.

Furthermore, since the film deposition is controlled with a plurality of measuring light beams having different wavelengths, even when an error is caused in the transmittance for any of the measuring light beams by the influence of another layer, the deposition end point is comprehensively determined by the transmittances for a plurality of other measuring light beams. Consequently, the accuracy in controlling the thicknesses of the layers in the multilayer film can be substantially increased.

In addition, since the deposition end point is estimated by comprehensively judging the degrees of phase advance calculated from the transmittances for all the measuring light beams, the estimation can be formed without respect to the extreme value, and a thin film having a thickness corresponding to λ/4 or less of the measuring wavelength λ can be produced.

When the film has a plurality of layers, since the phase estimating means calculates the degrees of phase advance by comparing the periodic changes expected from the layout of the plurality of layers and the changes in the light intensities monitored by the optical measurement means, the film deposition is controlled according to the degrees of phase advance for the measuring beams on the basis of phase changes determined from approximation curves corresponding to the measuring light beams that are fitted by the measured transmittance values. Therefore, the approximation curves for calculating the degrees of phase advance can be fitted with high precision without respect to the extreme value, and unlike the conventional methods, can produce a thin layer having a thickness corresponding to λ/b 4 or less of the measuring wavelength λ.

Preferably, the phase estimating means calculates the reciprocals of light intensities of the measuring light beams, and calculates the degrees of phase advance by comparing the periodic changes regressed by a cosine function or a sine function and the changes in the light intensities of the measuring light beams monitored by the optical measurement means. Therefore, the transmittance can be measured at points in the wide range other than the extreme value, and approximate curves for calculating the degrees of phase advance can be fitted with high precision. This can increase the accuracy in estimating the phase at the deposition end point and in obtaining the thickness of each layer, and thus can precisely produce a thin film having a thickness corresponding to λ/4 or less.

Preferably, the optical measurement means includes a combination of a wavelength-tunable light source and a light-intensity detecting means, and sequentially detects the phases of the different measuring light beams in time series. With a simple structure in which a plurality of measuring light beams with different wavelengths are emitted from the wavelength-tunable light source, the light intensities of the transmitted measuring light beams can be measured, the deposition end point can be easily estimated as described above from a plurality of measuring light beams, and thin films having a wavelength characteristic (spectral characteristic) can be formed.

Preferably, the optical measurement means includes a combination of a wavelength-tunable light source and a light-intensity detecting means, periodically sweeps the measuring wavelengths of a plurality of measuring light beams, measures changes in the light intensities of the measuring light beams, and determines the light intensities of the measuring light beams corresponding to the respective measuring wavelengths by parallel data processing. That is, instead of calculating the degree of phase advance on the basis of a measured transmittance every time a measurement is made with any of the plurality of measuring light beams, a plurality of transmittance values for the measuring light beams are periodically swept at fixed intervals, and are collectively (in parallel) processed in every interval. Since the number of wavelengths to be used can be adjusted by controlling the interval, the flexibility in setting the wavelengths can be increased.

Preferably, the optical measurement means includes a combination of a plurality of light sources for emitting measuring light beams having different wavelengths and a light-intensity detecting means. The light sources are arranged so that the optical axes of the light sources are at a small angle to a vertical axis of a surface to be measured and so that the measuring light beams pass through the same point on the surface to be measured. Since the thickness of the same area of the thin film is measured at the same time by taking the measurement at the same point with the plurality of measuring light beams, the number of types of measuring light beams can be increased, compared with the above-described structure in which measurement is taken in time series (sequentially). Moreover, errors among the transmittances of the measuring light beams due to differences in measuring position and measuring time can be reduced, and the accuracy in estimating the deposition end point can be increased.

Preferably, the optical measurement means includes a light source for emitting measuring light having broadband wavelength, and a spectroscopic means to separate the measuring light transmitted through the film into light components having different wavelengths. By measuring the light intensities of the separated light components in parallel, the number of wavelengths obtained by separation can be increased easily, and the obtained data on transmittances can be increased. Since the light intensities of all the transmitted light components are measured at the same time, the accuracy in estimating the deposition end point can be increased.

According to another aspect, the present invention provides an optical-thin-film deposition method including an optical measurement step of measuring the light intensities of a plurality of measuring light beams having different wavelengths that are transmitted or reflected by a film during deposition; a phase estimating step of calculating the phase of a point corresponding to a desired film thickness for each of the measuring wavelengths based on the relationship between the expected periodic change in the light intensity of the corresponding measuring light beam until the desired film thickness is reached, and the phase corresponding to the periodic change, and calculating the degree of phase advance by comparing the periodic change and the change in the light intensity of the measuring light beam monitored in the optical measurement step, the degree of phase advance representing the ratio of the phase of a point corresponding to the thickness of the film during deposition to the phase of the point corresponding to the desired film thickness; and a deposition control step of comprehensively determining a deposition end point based on the degrees of phase advance for all the wavelengths and of completing the film deposition at the deposition end point.

Preferably, phase differences between the phases of the points corresponding to the desired thickness for the measuring wavelengths and the phases of the points corresponding to the thickness of the film being deposited are calculated, and the deposition end point is calculated as a point at which the sum of squares of the phase differences of all the measuring wavelengths shows the minimum value.

Preferably, when the film has a plurality of layers, the degrees of phase advance are calculated in the phase estimating step by comparing the periodic changes expected from the layout of the layers and the changes of the light intensities monitored in the optical measurement step.

According to a further aspect, the present invention provides an optical filter formed of a multilayer thin film deposited by any of the above deposition apparatuses or by any of the above deposition methods. Therefore, even when the thicknesses of the layers are irregular, they precisely correspond to designed values. This makes it possible to obtain the optimal characteristics of an optical thin film, such as a gain flattening filter (GFF), that precisely adjusts the gain for each frequency.

Further objects, features and advantages of the present invention will become apparent from the following description of the preferred embodiments with reference to the attached drawings.

### BRIEF DESCRIPTION OF THE DRAWINGS

FIG. 1 is a block diagram showing a configuration of a deposition apparatus according to a first embodiment of the present invention;

FIG. 2 is an explanatory view showing a configuration of an apparatus body in the deposition apparatus shown in FIG. 1;

FIG. 3 is a conceptual view showing a configuration of an optical monitor sensor shown in FIG. 2;

FIG. 4 is a graph showing that the reciprocal of the transmittance periodically changes with time (horizontal axis);

FIG. 5 is a graph showing the relationship between the square (vertical axis) of the phase difference and time (horizontal axis);

FIG. 6 is a graph showing the relationship between an ideal change (solid line) in the square sum of the phase differences, and a quadratic regression curve given by Equation (8);

FIG. 7 is a graph showing the characteristic of the quadratic regression curve;

FIG. 8 is a flowchart showing the operation of the deposition apparatus according to the first embodiment of the present invention;

FIGS. 9A and 9B are conceptual views showing the configuration of a gain flattening filter (GFF) according to an embodiment of the present invention;

FIGS. 10A and 10B are conceptual views showing a configuration of an optical monitor sensor in a third embodiment of the present invention;

FIG. 11 is a conceptual view showing a configuration of an optical monitor sensor in a fourth embodiment of the present invention;

FIG. 12 is a cross-sectional view of a wavelength demultiplexer serving as an optical filter using multilayer thin films;

FIG. 13 is a conceptual view showing applications of edge filters and GFFs for use in a repeater for amplifying the attenuated intensity of a propagating optical signal;

FIG. 14 is a graph showing the relationship between the reflectance and the wavelength of incident light, which characterizes a bandpass filter;

FIG. 15 is a graph showing the amplification characteristics in accordance with the wavelength of the GFF;

FIG. 16 is a block diagram showing the configuration of a known deposition apparatus; and

FIG. 17 is a graph showing the correspondence between the transmittance (vertical axis) and the time (horizontal axis) during deposition, that is, a periodical phase change of the transmittance.

### DESCRIPTION OF THE PREFERRED EMBODIMENTS

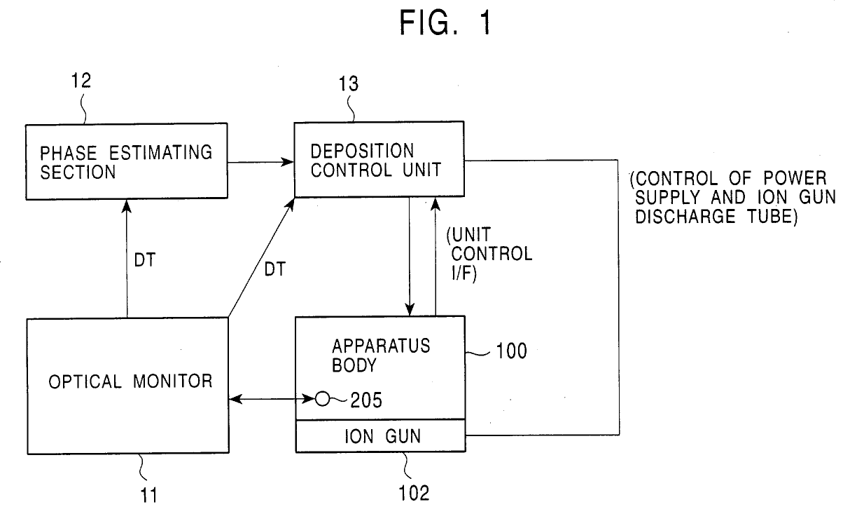

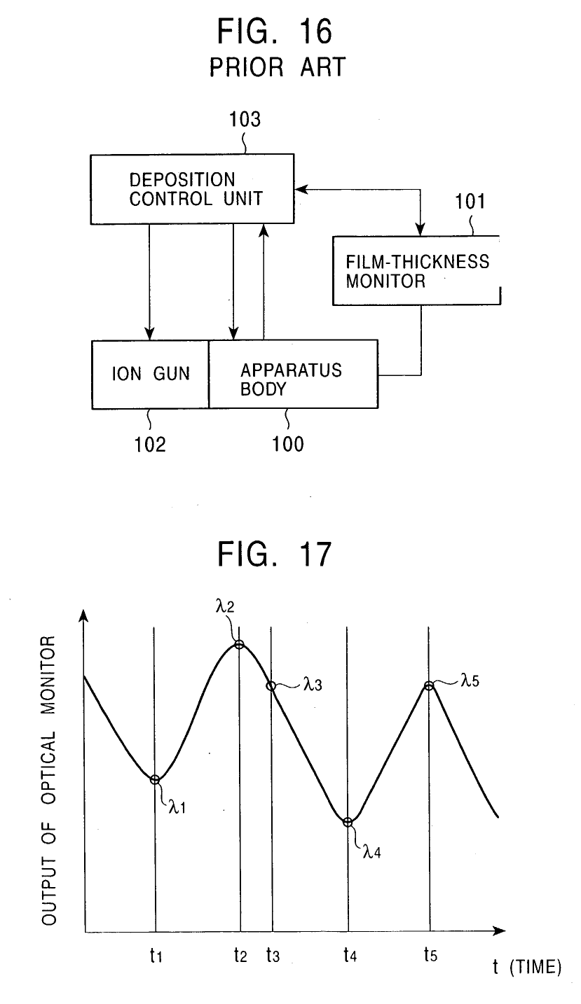

Preferred embodiments of the present invention will be described below with reference to the attached drawings. FIG. 1 is a block diagram showing the configuration of an optical-thin-film deposition apparatus according to a first embodiment of the present invention. Structures similar to those in the known deposition apparatus shown in FIG. 16 are denoted by the same reference numerals, and further descriptions thereof are omitted.

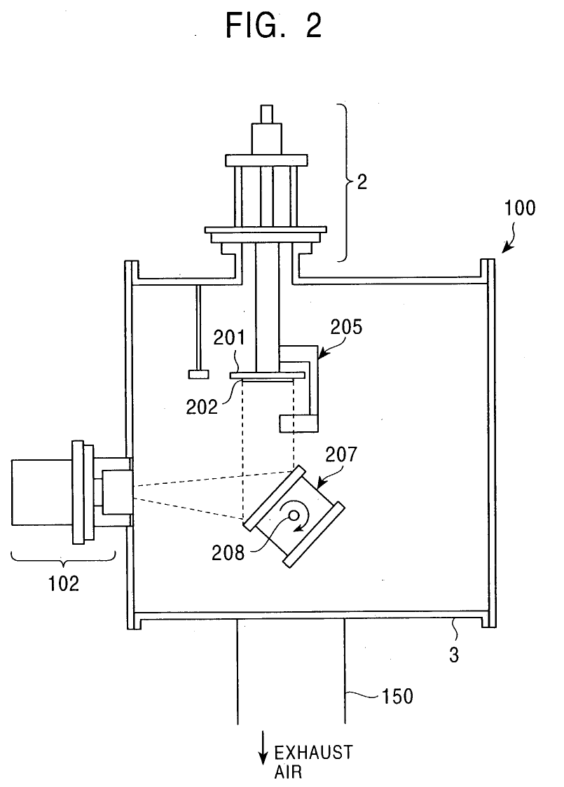

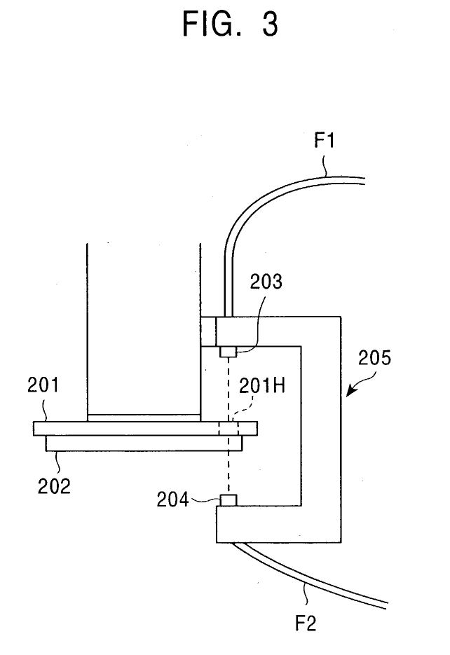

Referring to FIG. 1, digital data relating to the intensity of light to pass through a thin film during deposition (intensity of transmitted light) is transmitted from an optical monitor sensor 205 (see FIGS. 2 and 3) to an optical monitor 11, as will be described later. The optical monitor sensor 205 is provided in a vacuum chamber 3 of an apparatus body 100, and is composed of a light projecting section and a light receiving section.

In the optical monitor sensor 205, measuring light beams having different wavelengths are emitted in a time-divisional manner (at regular intervals and in time series) from the light projecting section having a wavelength-tunable light source. The light receiving section sequentially transmits, to the optical monitor 11, measured voltages corresponding to the intensities of measuring light beams that are transmitted through a thin film in synchronization with the switching among the wavelengths of the measuring light beams.

For example, in one embodiment, the wavelength range used for a filter is divided at predetermined intervals, and the wavelengths at the dividing points are used as the wavelengths of the measuring light beams. In general, the wavelengths of the measuring light beams do not need to be equally spaced from one another.

The optical monitor 11 converts the measured voltages sequentially received from the optical monitor sensor 205 into digital data, and sends transmittance value data DT {DT1, DT2, . . . } of the converted digital data to a phase estimating section 12 in time series (i.e., sequentially).

As used herein, DT1, DT2, . . . represent transmittance data for each of the measuring light beams having different wavelengths that are sent in time series. Hereinafter, the transmittance data DT represents a data row {DT1, DT2, . . . }.

FIG. 2 shows detailed configurations of the apparatus body 100 and an ion gun 102 shown in FIG. 1.

A substrate 202 on which a multilayer film is to be formed is fixed onto a substrate holder 201 that is connected to a substrate-holder rotating mechanism 2.

The substrate-holder rotating mechanism 2 includes a motor and other conventional elements, and rotates the substrate holder 201 so that atoms and molecules applied from a target 207 can be uniformly deposited on the substrate 202.

The ion gun 102 accelerates generated ions, irradiates a material located on the surface of target 207 for deposition with an ion beam, and applies the material from the target 207 onto the substrate 202 by means of energy of the ion beam.

The target 207 is rotatable on a rotation shaft 208, and can apply a plurality of film materials onto the substrate 202 by directing a predetermined material surface into the path of the ion beam from the ion gun 102.

The vacuum chamber 3 exhausts air and gas (materials that are applied from the target 207, but are not deposited anywhere) through an exhaust opening 150 by a vacuum pump (not shown) in order to adjust the degree of vacuum.

In a system for optically measuring the film thickness, the optical monitor sensor 205 has a configuration in one embodiment as shown in FIG. 3. FIG. 3 is a conceptual view showing a detailed configuration of the optical monitor sensor 205.

A light projecting section 203 is provided inside the vacuum chamber 3 (see FIG. 2) to direct a measuring light beam having a predetermined wavelength transmitted through an optical fiber F1 onto the back surface of the substrate 202 through a window 201H that is formed in the substrate holder 201 to permit the measuring light beam to pass through it.

A light receiving section 204 includes a condenser lens and sends transmitted light received from (i.e., passing through) the substrate 202 to the optical monitor 11 through an optical fiber F2.

While the optical monitor sensor 205 is placed inside the vacuum chamber 3 in this embodiment, the light projecting section 203 and the light receiving section 204 may be placed outside the vacuum chamber 3 to measure the intensity of light transmitted through the substrate 202, to and/or from outside the vacuum chamber 3 through a glass window (not shown) formed in the vacuum chamber 3.

Referring again to FIG. 1, the optical monitor 11 inputs transmitted light from the light receiving section 204 (see FIG. 3) of the optical monitor sensor 205 provided in the vacuum chamber 3, and generates a detection signal of a voltage in accordance with the intensity of the transmitted light.

The optical monitor 11 also subjects the detection signal to A/D conversion, calculates digital transmittance data DT from the strength ratio between the detection signal and a detection signal obtained when a thin film is not formed, and outputs the transmittance data DT to the phase estimating section 12.

On the basis of the transmittance data DT input from the optical monitor 11, a deposition control unit 13 determines whether the optical monitor 11 is operating normally.

The deposition control unit 13 also controls a power supply necessary for discharge of the ion gun 102, and controls the degree of vacuum of the vacuum chamber 3. The phase estimating section 12 causes the ion gun 102 to start emission of an ion beam under the control of the deposition control unit 13, determines whether the thickness of a thin film during deposition reaches a designed thickness on the basis of the input transmittance data DT, and stops the ion gun 102 from discharging the ion beam onto the target 207.

The phase estimating section 12 converts input transmittance data DT (DT1, DT2, DT3, . . . ) associated with the measuring light beams into transmittances T (T1, T2, T3, . . . ) and sequentially finds, on the basis of the transmittances T in conjunction with each measuring light beam (that is, each transmittance T), the degree of phase advance representative of the thickness of the thin film during deposition.

The following equations (1) to (6) for calculating the degree of phase advance are solved by the phase estimating section 12.

Herein, the phase of the point corresponding to the film thickness of the thin film during deposition shows a value defined by a trigonometric function, because a change in transmittance (intensity of measuring light transmitted through the thin film) is expressed by a periodic function of time, as shown in FIG. 17.

That is, in the multilayer-film theory, when it is assumed that light perpendicularly enters the surface of a multilayer film, a characteristic matrix of a j-th layer in the multilayer film is given by the following Equation (1):

$${M}_{j} = [ \begin{matrix}cos {δ}_{j} & ( i sin {δ}_{j} ) / {n}_{j} \\ i {n}_{j} sin {δ}_{j} & cos {δ}_{j}\end{matrix} ] \qquad ( 1 )$$

In Equation (1), i is a complex number, nⱼ represents the refractive index of the j-th layer, and the phase angle δⱼ is given by the following Equation (2):

$${δ}_{j} = \frac{2 π {n}_{j} r t}{λ} \qquad ( 2 )$$

In Equation (2), λ represents the wavelength of incident light, and dⱼ (i.e., r·t) represents the physical thickness of the j-th layer.

A characteristic matrix M of the multilayer film constituted by the N-number of layers is given by the following Equation (3):

$$M = [ \begin{matrix}{m}_{11} & i {m}_{12} \\ i {m}_{21} & {m}_{22}\end{matrix} ] = {\prod }_{j = 1}^{N} {M}_{j} \qquad ( 3 )$$

When elements of the characteristic matrix M are expressed by m11, m12, m21, and m22, the transmittance T of the multilayer film is given by the following Equation (4) that represents the energy transmittance:

$$T = {ττ}^{*} \cdot \frac{{n}_{s}}{{n}_{0}} \qquad ( 4 )$$

In Equation (4), τ* is a complex conjugate of τ, and τ is given by the following Equation (5):

$$τ = \frac{2 {n}_{0}}{( {m}_{11} + i {m}_{12} {n}_{s} ) {n}_{0} + ( i {m}_{21} + {m}_{22} {n}_{s} )} \qquad ( 5 )$$

In Equation (5), n₀ represents the refractive index of a medium, and nₛ represents the refractive index of a substrate on which the thin film is deposited.

A change in transmittance T of a layer during deposition can be estimated by calculation using the above equations.

By expressing all the completed layers by one characteristic matrix and making the elements of the characteristic matrix constants, a secular change of the characteristic matrix of a layer during deposition can be reflected in a change in transmittance T.

That is, as is clear from the above Equations (2), (3), and (4), a change in transmittance T of the layer during deposition can be expressed as a change in physical thickness.

When it is assumed that the deposition rate r and the refractive index of a layer during deposition are fixed, since the physical thickness dⱼ of the layer is proportional to the deposition time t, it can be expressed by r·t, and a change in physical thickness can be replaced with a change in deposition time t (in the case of a completed film, r·t in Equation (2) equals the physical thickness dⱼ).

As shown in the following Equation (6), since the reciprocal of the transmittance T is expressed by a cosine function, it is possible to easily perform linear fitting (fitting with the measured transmittance T) in which the change in transmittance T of the film during deposition is a function of time.

$${F}_{( t )} = 1 / T = {a}_{0} + {a}_{1} cos ( {a}_{2} \cdot t + {a}_{3} ) \qquad ( 6 )$$

For this reason, a measured phase PS at the present time during deposition can be found in real time by a periodic function that is regressed by the cosine function in Equation (6) subjected to the fitting at a plurality of measuring points of the transmittance T, and that periodically changes with time.

A target phase PT (that is, coefficients a₀ to a₃ in Equation (6) to calculate a₂·t+a₃) at which the film deposition is terminated is calculated beforehand by the theoretical Equations (1) to (6) based on the physical thickness of a thin film to be formed when a multilayer film is designed, and the target phase PT and the measured phase found in real time (a₂·t+a₃ given by Equation (6) on the basis of the reciprocal of the measured transmittance T) are sequentially compared at measuring points (sampling times) for the transmittance T, thereby calculating the degree of phase advance that represents the ratio between the target phase and the measured phase.

In this case, the fitting of Equation (6) is performed while adjusting the coefficients a₀ to a₃ so that the reciprocal of the transmittance T calculated from the time in theoretical Equation (6) and the measured transmittance T coincide with each other.

The phase estimating section 12 calculates the degree of phase advance as the square (ΔPn)² of a phase difference (PTn−PSn=ΔPn) that is, of the phase difference of the measured phase from the target phase, and sends the value so determined to the deposition control unit 13.

Herein, n represents the number of any of measuring light beams having different wavelengths.

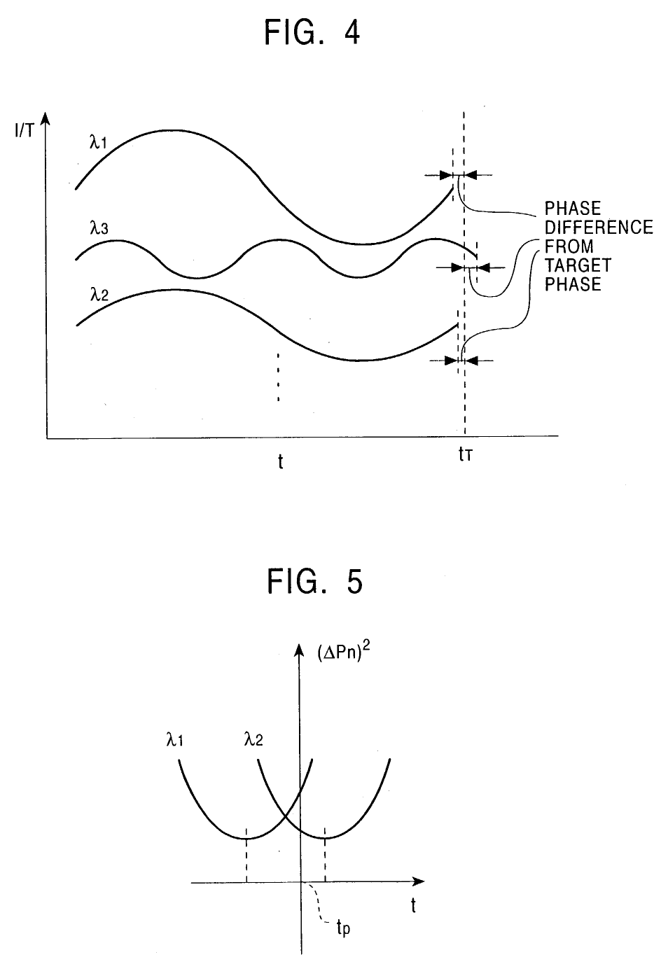

For example, in the relationship between the time (horizontal axis) and the reciprocal of the transmittance T (1/T, vertical axis) shown in FIG. 4, it is ideal that a periodic function of the reciprocal of the transmittance T corresponding to each measuring wavelength (λ1, λ2, λ3, . . . ) coincides with the target phase set corresponding to the measuring wavelength at the same time t_{T}.

As described in conjunction with the problems, however, the time at which the measured phase reaches the target phase varies around the time t_{T} among the measuring light beams, for example, because of measurement errors of the transmittance T and the interference of the thin film with the measuring light beams.

That is, in the phase estimating section 12, errors occur in the phase advances because of the differences in wavelength among the measuring light beams, and the degrees of phase advance to be calculated deviate.

Since these errors cannot be absorbed by monochromatic light, as described above, the deposition control unit 13 comprehensively determines the deposition end point on the basis of the phase differences obtained for the respective measuring light beams.

The deposition control unit 13 receives values for the degrees of phase advance for the respective measuring light beams from the phase estimating section 12, and calculates, based on these degrees of phase advance, a deposition end point (deposition end time) at which point the film deposition is terminated.

In this case, the deposition control unit 13 calculates a deposition end time tₚ, at which the sum of the degrees of phase advance (the squares of the phase differences in this embodiment) for all the measuring light beams (the square sum of the phase differences for the respective measuring light beams, Σ(ΔPₙ)²) shows the minimum value, by regression using a change curve formed by the sum of the values plotted from the beginning of the deposition to the present time.

The above sum, that is, the sum of the squares of the phase differences means the sum of the squares of phase differences between measured phases that are calculated from the reciprocals of the transmittances T (T1, T2, T3, . . . ) for the respective measuring light beams obtained by sampling, and designed target phases for the measuring light beams.

The deposition control unit 13 judges the deposition end time tₚ the deposition end point, determines that the desired optical thickness is reached at this time, and terminates the formation of the thin film.

When the deposition end time tₚ is earlier than a time at which the next sampling operation is performed (started), the deposition control unit 13 sets the deposition end time tₚ as a formal deposition end time, and stops the discharge of the ion beam by the ion gun 102.

That is, even when the deposition control unit 13 stops the ion application by the ion gun 102 at the time at which the extreme value on the change curve is detected, the film deposition is continued during the detection of the extreme value, and the thickness of the film exceeds the preset thickness.

For this reason, the deposition control unit 13 subjects the received values for degrees of phase advance to signal processing to estimate the time at which the extreme value is obtained, and stops the ion gun 102 at the estimated time, thereby reducing the delay time between the detection of the extreme transmittance and the stopping of the application by the ion gun 102.

For the above reasons, the extreme value of the transmittance of the thin film during deposition is estimated. For example, estimation is formed in the following method.

The deposition end point (the time at which the extreme value as the minimum value is obtained) is estimated by the deposition control unit 13 by detecting the extreme value on the change curve, for example, in the following method using a quadratic regression function.

The squares of phase differences corresponding to the measured values that are input to the deposition control unit 13 are shown by quadratic curves shown in FIG. 5.

The deposition control unit 13 calculates the received values for squares of phase differences as the square sum, and estimates the deposition end time tₚ at which a change curve formed by the square sum (i.e., sum of squares)of the phase differences shows the minimum value.

The change curve can usually be approximated in the region adjacent to the extreme value of the square sum of phase differences by the following polynomial Equation (7). The approximation can be obtained even when the fourth term and subsequent terms are omitted:

y=bo+b1·t+b2·t²+b3·t⁴+b4·t⁶+. . . (7)

In Equation (7), b0, b1, b2, b3, b4, . . . are coefficients that are to be obtained by regressive calculation.

In this case, the transmittances of the substrate 202 and the thin film formed thereon are actually expressed by more complicated functions because of the complexity produced by the process for stacking multiple layers, nonuniformity of the refractive index of the layers, and linearity of current amplification in the light receiving section 204 and the optical monitor 11.

However, the approximation can be obtained near the extreme value by omitting the fourth term and subsequent terms in Equation (7).

y=b0+b1·t+b2·t² (8)

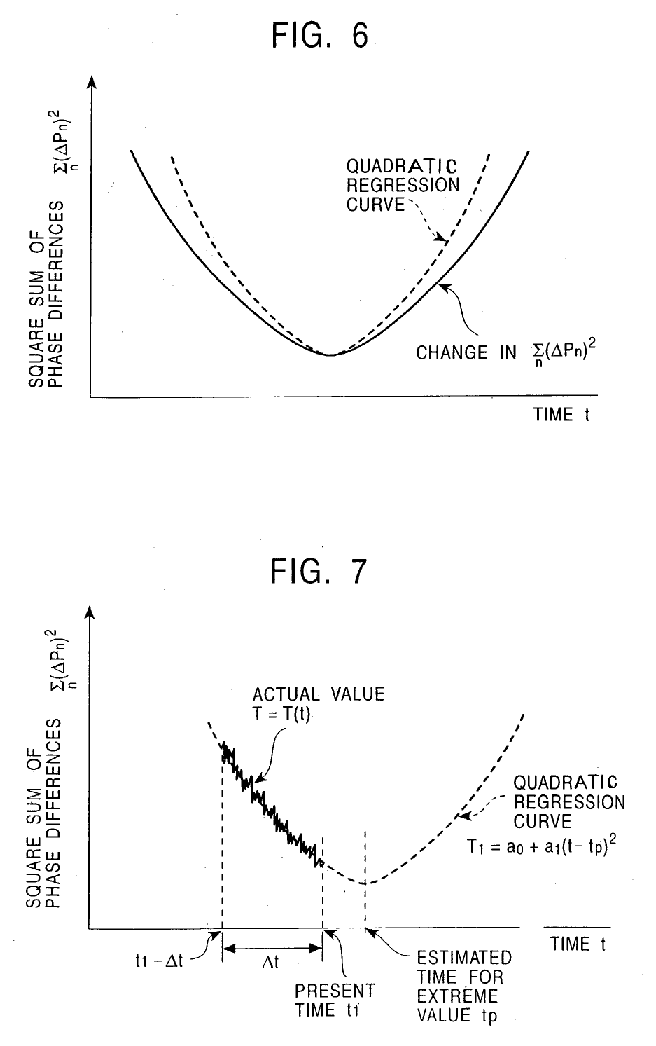

As shown in FIG. 6 (horizontal axis: time, vertical axis: square sum of phase differences), Equation (8) is expressed by a quadratic regression curve (broken line), that is, a quadratic regression function which approximates Equation (7) and shown by the solid line as a theoretical change of the square sum of phase differences. In Equation (8), b0 to b2 are coefficients.

Since noise is superimposed on the sampled transmitted light as in the measured value T(t), as shown in FIG. 7 (horizontal axis: time, vertical axis: square sum of phase differences), the square sum of phase differences is found as a value including the noise. In FIG. 7, the quadratic regression curve is shown by a broken line.

The deposition control unit 13 calculates a differential value of the quadratic regression function in Equation (8), that is, the inclination of a tangent line by the following Equation (9):

dy/dt=b1+2·b2·t (9)

The deposition control unit 13 calculates the time at which the inclination of the broken line equals 0, and estimates the time tₚ at which the square sum of phase differences corresponding to a plurality of measuring light beams having different wavelengths shows the extreme value.

That is, the time tₚ is given by tₚ=−b1/(2·b2).

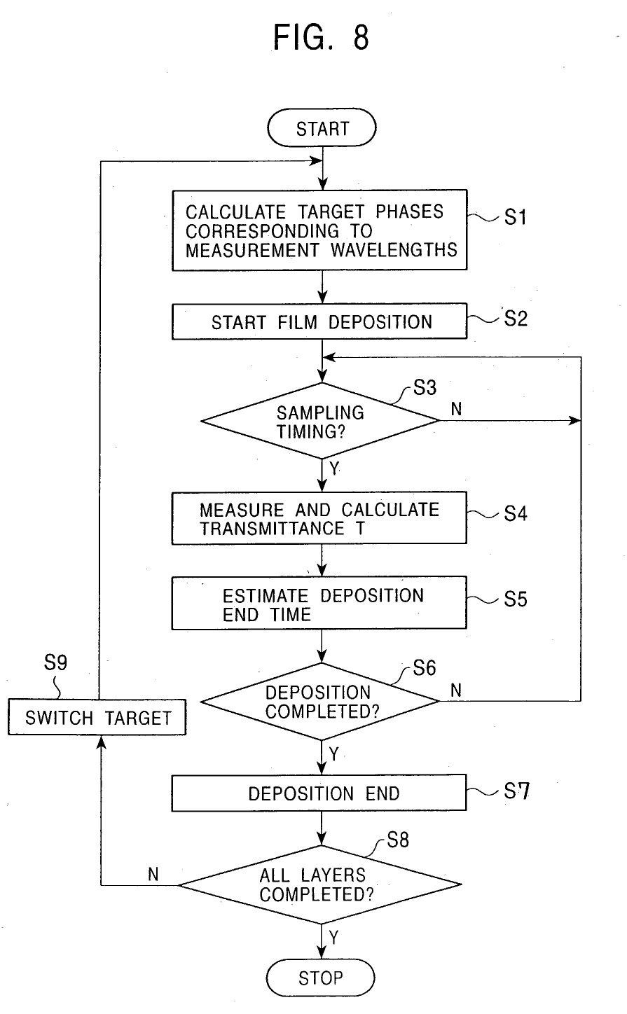

Next, the operation of the first embodiment will be described with reference to FIGS. 1, 2, and 8. FIG. 8 is a flowchart showing an example of an operation of the film deposition apparatus of the first embodiment.

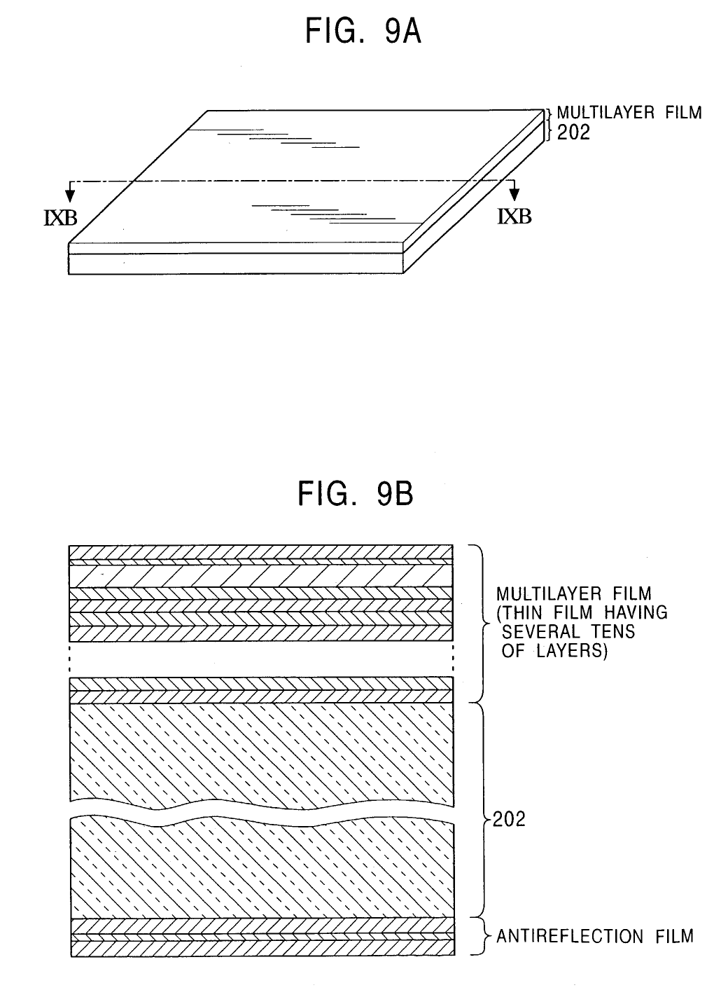

For example, a description will be given of a case in which a GFF is formed by stacking a plurality of (several tens of) thin layers that are different in thickness and material on a front surface of a substrate 202 made of a glass (ceramic) material, as shown in FIGS. 9A and 9B. FIG. 9A is a perspective view of the GFF, and FIG. 9B is a cross sectional view of the GFF, taken along line IXB-IXB in FIG. 9A.

An antireflection film for light with predetermined wavelengths is formed on a back surface of the substrate 202 after the multilayer film is formed on the front surface.

In Step S1, the phase estimating section 12 calculates target phases for measuring light beams to be used by the above Equations (1) to (6) on the basis of the film thicknesses of the layers of a multilayer film to be formed, and stores the calculated target phases.

In Step S2, the deposition control unit 13 actuates the ion gun 102 to start the deposition of a predetermined layer (the layers are sequentially formed from the first layer on the front surface of the substrate 202).

In Step S3, the phase estimating section 12 determines whether the sampling time (arbitrarily set in accordance with the accuracy in controlling film thickness) at which the transmittance T is measured has come, on the basis of clock data from an internal timer.

In this case, the phase estimating section 12 detects that the sampling time has not come, Step S3 is performed again after a predetermined time.

In contrast, when the phase estimating section 12 detects that the sampling time has come, Step S4 is performed.

In Step S4, the phase estimating section 12 causes the optical monitor 11 to start the measurement of the transmittance.

In response to this, the optical monitor 11 sequentially measures the intensity of transmitted light while switching among the measuring light beams while controlling the optical monitor sensor 205, and sends transmittance data DT (DT1, DT2, . . . ) in time series to the phase estimating section 12.

Every time the transmittance data DT is received, the phase estimating section 12 converts the transmittance data DT into a transmittance T, calculates a measured phase according to Equation (6), calculates the square of a phase difference of the measured phase from a target phase corresponding to the measuring wavelength, and outputs the square to the deposition control unit 13.

In Step S5, the deposition control unit 13 estimates the deposition end point according to Equations (7) to (9) on the basis of the phase differences received sequentially corresponding to the measuring wavelengths.

In Step S6, when the obtained deposition end point (deposition end time) does not reach the next sampling time for the transmittance T (i.e., the sampling time is shorter than the sum of the present time and the sampling period), the deposition control unit 13 sets the obtained deposition end point as a conclusive deposition end point, and Step S7 is performed.

In Step S7, when the deposition control unit 13 detects that the time counted by the timer reaches the deposition end point, it stops the ion gun 102, and terminates the deposition of the predetermined thin layer.

In Step S6, when the obtained deposition end point (deposition end time) exceeds the next sampling time for the transmittance T (the time is longer than the sum of the present time and the sampling period), the deposition control unit 13 does not set the deposition end point as a conclusive deposition end point, and Step S3 is performed again.

In Step S8, for example, the deposition control unit 13 detects whether the deposition of all the layers of a multilayer film in a multilayer-film optical filter is completed. When it is detected that all the layers have been completed, the deposition on the substrate 202 is terminated. When it is detected that all the layers have not been completed, Step S9 is performed.

In Step S9, the deposition control unit 13 executes control to rotate the target 207 so that ions from the ion gun 102 are applied to a predetermined film material, and Step S1 is started again.

The deposition control unit 13 repeats Step S1 to Step S8 until it is detected in Step S8 that all the layers of the multilayer film have been completed. In this way, the deposition control unit 13 controls the deposition of a plurality of layers in a multilayer thin film filter.

Since the above-described optical-thin-film deposition apparatus according to the present invention uses the wavelength-tunable light source as a light source for measuring light in the optical monitor sensor 205, a plurality of measuring light beams having different wavelengths can be used to measure the transmittance T of the thin film. On the basis of a plurality of transmittances for a plurality of measuring light beams having different wavelengths, the phase estimating section 12 calculates the degrees of phase advance (the squares of phase differences between the target phases and the measured phases) for the respective wavelengths. When the deposition control unit 13 sets, as the deposition end time, the time at which these degrees of phase advance reach the minimum value, the deposition of a predetermined layer is terminated. Therefore, the influences of errors in measuring the transmittance, interference, and the like that cannot be prevented by only monochromatic light can be reduced by sampling a plurality of transmittances at a similar timing, and comprehensively judging the transmittances to determine the deposition end point.

Consequently, even when measured transmittance values fluctuate because of disturbance or the like, the deposition end point is comprehensively estimated by the degrees of phase advance for the respective measuring light beams on the basis of the phase changes on the approximation curves corresponding to the wavelengths that are fitted by the measured transmittances (intensity of transmitted light) for all the measuring beams. Therefore, it is possible to execute control that is more resistant to noise, such as disturbance, than when the film deposition is controlled using monochromatic light. Moreover, since the deposition control unit 13 comprehensively judges the degrees of phase advance calculated from the transmittances measured for all the measuring light beams, and thereby estimates the deposition end point, the deposition end point can be estimated without respect to the extreme value, and a thin film having a thickness of λ/4 or less of the measuring wavelength λ can be produced.

In the optical-thin-film deposition apparatus of the present invention, the optical monitor sensor 205 includes a combination of the light projecting section 203 formed of a wavelength-tunable light source, and the light receiving section 204 for detecting the intensity of light, and the optical monitor 11 sequentially detects the phases corresponding to the different measuring wavelengths in time series. Consequently, by using a simple structure in which a plurality of measuring light beams having different wavelengths are applied from the wavelength-tunable light source, a plurality of measuring wavelengths can be easily used, and the manufacturing cost of the apparatus can be reduced.

While the first embodiment of the present invention has been described in detail above, specific structures are not limited to those described in this embodiment, and the present invention includes design changes and other alternatives without departing from the scope or the spirit of the invention.

For example, in Step S4 shown in FIG. 8, while the optical monitor 11 measures the transmittance data DT while changing the wavelength of measuring light emitted from the wavelength-tunable light source in time series, and sequentially transmits the data to the phase estimating section 12 in the first embodiment, in a second embodiment of the present invention, the wavelength of the measuring light may be swept within a predetermined wavelength band (for example, a wavelength band used by a multilayer film filter to be formed), and the intensity of the measuring light having predetermined wavelengths transmitted through the thin film may be measured and may be collectively sent to the phase estimating section 12.

With the above features, the optical-thin-film deposition apparatus according to the present invention provides the following advantages in addition to the advantages of the first embodiment. That is, the optical monitor sensor 205 includes a combination of the light projecting section 203 formed of a wavelength-tunable light source, and the light receiving section 204 for detecting the intensity of light, periodically sweeps the measuring wavelengths, measures changes in intensity of transmitted light beams having a plurality of predetermined measuring wavelengths preset in the wavelength band, and determines the light intensities of the light beams by parallel data processing. Since a plurality of transmittances T for the measuring light beams, which are periodically swept, are measured at fixed intervals, and are collectively (in parallel) processed in every interval, without calculating the degree of phase advance every time the transmittance T is measured with any of a plurality of measuring light beams. Therefore, it is possible to adjust the interval, to adjust the number of wavelengths to be used, and to achieve more flexibility in setting the measuring wavelengths than when the wavelengths of the measuring light is sequentially adjusted and set.

An alternative embodiment may be employed in a third embodiment of the present invention. That is, in Step S4 shown in FIG. 8, while the optical monitor 11 measures the transmittance data DT while changing the wavelength of measuring light emitted from the wavelength-tunable light source in time series, and sequentially transmits the data to the phase estimating section 12 in the first embodiment, a plurality of light sources (not shown), a plurality of light projecting sections 203, and a plurality of light receiving sections 204 are arranged to collectively (in parallel) process in each cycle a plurality of transmittances T that are measured periodically.

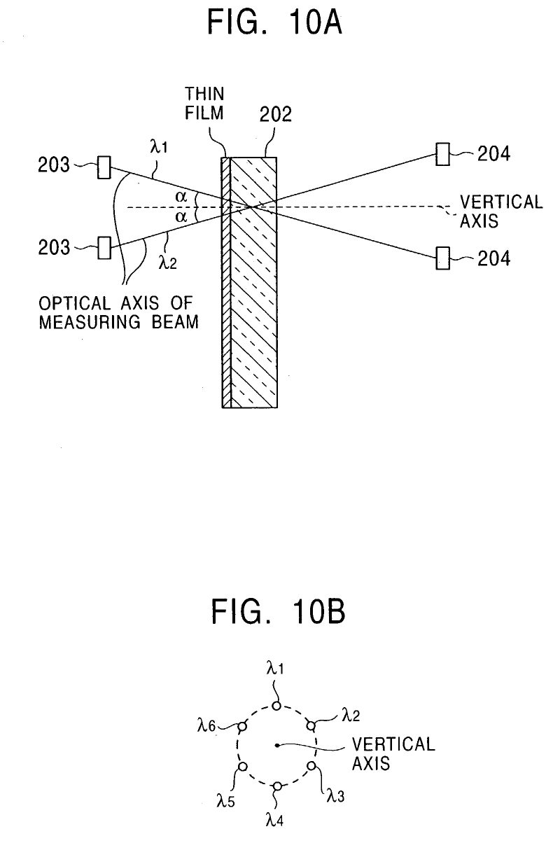

The optical monitor sensor 205 may have a structure in which a plurality of light projecting sections 203 for projecting light beams having different wavelengths (λ1, λ2, λ3, . . . ) are placed at a predetermined small angle α to the vertical axis perpendicular to the surface of the substrate 202, and a plurality of light receiving sections 204 are placed corresponding to the light projecting sections 203, as shown in FIG. 10A.

Alternatively, one light receiving section 204 may be used for a plurality of light projecting sections 203, and may be switched in a time divisional manner corresponding to any of the light projecting sections 203.

In this case, as shown in FIG. 10B, the optical axes of the measuring light beams are placed on the circumference of a circle centered on the vertical axis, as viewed from the top of the substrate 202.

Consequently, in the film deposition apparatus of the present invention, each of the optical axes can be placed at the small angle α to the vertical axis, and thus can reduce differences in the measuring condition among the measuring light beams.

While the optical monitor 11 sequentially takes measurement with the measuring light beams in order to prevent interference among the measuring light beams, the order in which the light beams are used may be changed in every sampling cycle.

For example, the optical monitor 11 may change the order in which the wavelengths are used, from λ1, λ2, λ3, λ4, λ5, λ6, . . . to λ2, λ3, λ4, λ5, λ6, . . . , λ1 in the next sampling, and to λ3, λ4, λ5, λ6, . . . , λ1, λ2 in sampling subsequent to the next sampling.

Accordingly, the third embodiment provides the following advantages in addition to the advantages of the first and second embodiments. That is, deviation due to the measuring position in sampling is corrected, and the transmittance is constantly measured under random conditions. Therefore, it is possible to remove errors resulting from the time in fitting, to calculate the degree of phase advance with high precision, and to precisely execute the film deposition control.

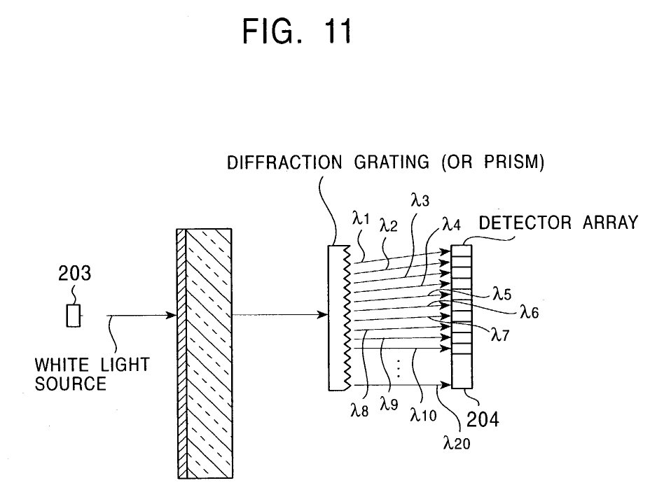

According to a fourth embodiment of the present invention, in Step S4 shown in FIG. 8, instead of the optical monitor 11 measuring the transmittance data DT while sequentially changing the wavelength of measuring light emitted from the wavelength-tunable light source, and sequentially transmits the data to the phase estimating section 12 in the first embodiment, a light projecting section 203 may be formed of a white light source using halogen or the like, measuring light transmitted through a thin film and a substrate 202 may be separated into light components having different wavelengths by a diffraction grating (or prism), and the light intensity of each of the separated light components may be measured by a light receiving section 204 formed of a detector array having a plurality of photoreceptors to obtain transmittance data DT, as shown in FIG. 11.

With these features, the fourth embodiment provides the following advances in addition to the advances of the first embodiment. That is, white light is used as measuring light, the light transmitted through the substrate 202 is separated into a plurality of light components having different wavelengths, and the light intensities of the light components are found individually. Therefore, it is possible to easily increase the number of wavelengths obtained by separation, and to easily increase the amount of obtained transmittance data. Moreover, since the light intensities of all the transmitted light components are measured at the same time, the degrees of phase advance at the same timing are obtained, and measurement differences due to time among the transmittances T corresponding to the measuring wavelengths (differences among the measured values due to time for the film during deposition) can be removed. As a result, the accuracy in estimating the deposition end point can be increased.

Next, a description will be given of an optical device to which multilayer thin films produced by the above-described optical-thin-film deposition method and apparatus of the present invention are applied.

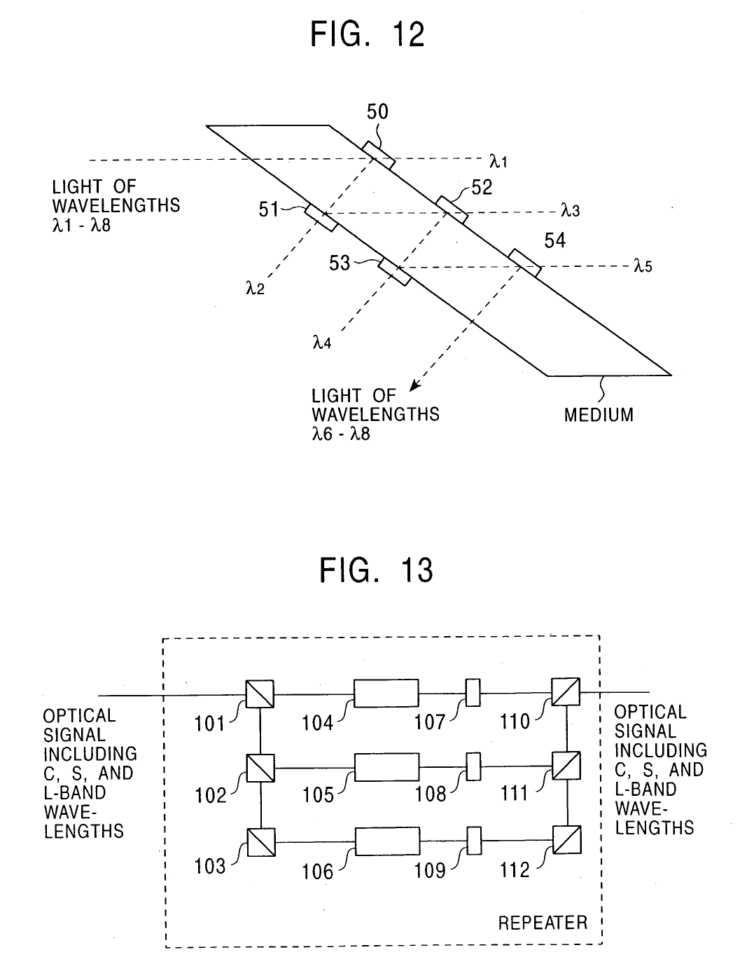

FIG. 12 is a cross-sectional view of a wavelength demultiplexer serving as an optical filter using multilayer thin films.

In the wavelength demultiplexer shown in FIG. 12, optical band pass filters (“BPF's”) 50, 51, 52, 53, and 54 each formed of a multilayer thin film produced by the method and apparatus of the present invention are attached to a medium.

For example, an optical signal having wavelengths λ1 to λ8 is received at an input of the wavelength demultiplexer, and is separated into optical signals of λ1, λ2, λ3, λ4, and λ5 by the BPFs 50, 51, 52, 53, and 54, and the optical signals are then transmitted as output signals from the wavelength demultiplexer.

Therefore, the wavelength demultiplexer separates the received optical signal (i.e., received at the input of the demultiplexer) having a plurality of wavelengths into optical signals having different wavelengths, and then transmits the optical signals out of the demultiplexer.

FIG. 13 shows edge filters serving as optical filters, and GFFs used in a repeater that amplifies the attenuated intensity of a propagating optical signal in optical transmission.

In the edge filters 101 and 102, the reflectances for predetermined wavelengths are adjusted, and transmission of optical signals having the wavelengths is controlled.

For example, the edge filter 101 has a high reflectance for C-band and L-band wavelengths, and transmits only S-band optical signals so that the optical signals can enter a fiber amplifier (optical amplifier adapted for the S-band wavelength) 104.

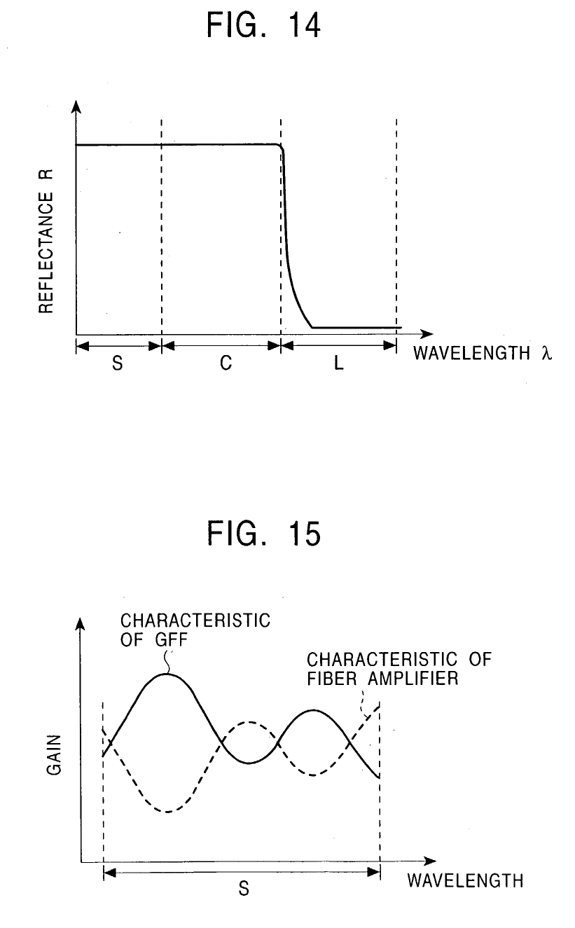

The edge filter 102 has a high reflectance for S-band and C-band wavelengths, and transmits only L-band optical signals, as shown in FIG. 14.

Therefore, while the edge filter 102 causes S-band and C-band optical signals to enter a fiber amplifier 105 (optical amplifier adapted for the C-band wavelength), since the S-band light is caused by the edge filter 101 to enter the fiber amplifier 104, only the C-band optical signals substantially enter the fiber amplifier 105.

An edge filter 103 has a high reflectance for S-band, C-band, and L-band wavelengths to reflect S-band, C-band, and L-band optical signals.

The S-band includes optical signals having wavelengths ranging from 1450 nm to 1485 nm, the C-band includes optical signals having wavelengths ranging from 1530 nm to 1560 nm, and the L-band includes optical signals having wavelengths ranging from 1565 nm to 1610 nm.

While the fiber amplifiers 104 to 106 amplify the S-band, C-band, and L-band optical signals, respectively, gains thereof differ depending on the wavelengths within the band.

For example, as shown in FIG. 15, the gain characteristic of the fiber amplifier 104 is not flat, and varies depending on the wavelength.

GFFs 107 to 109 are optical filters that have gain characteristics, respectively, reverse to the gain characteristics of the fiber amplifiers 104, 105, and 106, as shown in FIG. 15, and are used to flatten the light intensities amplified by the fiber amplifiers 104, 105, and 106.

Since a thin film can be precisely deposited by the film deposition apparatus of the present invention, it is possible to produce the above-described BPFs, edge filters, and GFFs having high-precision frequency characteristics.

While the thickness of the thin film is measured using the transmittance in the first to fourth embodiments, of course, similar advantages can be achieved by measuring the intensity of light reflected by a thin film that is being deposited, and using, instead of the transmittance, the reflectance found by the intensity of the reflected light to control the film deposition in the processes and calculations in the first to fourth embodiments.

Furthermore, while the point (time) at which the square sum (i.e., sum of the squares)of phase differences between target phases and measured phases for a plurality of measuring light beams shows the minimum value is estimated as the deposition end point in the first to fourth embodiments, similar advantages can be obtained by estimating, as the deposition end point, the point (time) at which the sum of absolute values of the phase differences shows the minimum value.

What is claimed is:

1. A film deposition apparatus comprising:
an optical measurement unit for measuring the light intensities of a plurality of measuring light beams having different wavelengths that are transmitted or reflected by a film during deposition;
a phase estimating unit for calculating the phase of a point corresponding to a desired film thickness for each of the measuring wavelengths based on the relationship between the expected periodic change in the light intensity of the corresponding measuring light beam until the desired film thickness is reached, and the phase corresponding to the expected periodic change, and calculating the degree of phase advance by comparing the expected periodic change and the change in the light intensity of the measuring light beam monitored by the optical measurement unit, the degree of phase advance representing the ratio of the phase of a point corresponding to the thickness of the film during deposition to the phase of the point corresponding to the desired film thickness; and
a deposition control unit for comprehensively determining a deposition end point based on the degrees of phase advance for all the wavelengths and for completing the film deposition at the deposition end point.

2. A film deposition apparatus according to claim 1, wherein, when the film has a plurality of layers, the phase estimating unit calculates the degree of phase advance by comparing the periodic change expected from the layout of the plurality of layers and the change in the light intensity monitored by the optical measurement unit.

3. A film deposition apparatus according to claim 1, wherein the phase estimating unit calculates the reciprocal of the light intensity of each of the measuring light beams, and calculates the degree of phase advance by comparing the periodic change regressed by a cosine function or a sine function and the change in the light intensity of the measuring light beam monitored by the optical measurement unit.

4. A film deposition apparatus according to claim 1, wherein the optical measurement unit includes a combination of a wavelength-tunable light source and a light-intensity detecting unit, and sequentially detects the phases of the different measuring light beams in time series.

5. A film deposition apparatus according to claim 1, wherein the optical measurement unit includes a combination of a wavelength-tunable light source and a light-intensity detecting unit, periodically sweeps the measuring wavelengths of the measuring light beams, measures changes in the light intensity of each of the measuring light beams, and determines the light intensity of the measuring light beam by parallel data processing.

6. A film deposition apparatus according to claim 1, wherein the optical measurement unit includes a plurality of light sources for emitting measuring light beams having different wavelengths and a light-intensity detecting unit in combination, and the light sources are arranged so that the optical axes thereof are at a small angle to a vertical axis of a surface to be measured and so that the measuring light beams pass through the same point on the surface to be measured.

7. A film deposition apparatus according to claim 1, wherein the optical measurement unit includes a light source for emitting measuring light having broadband wavelength, and a spectroscopic unit, and the light intensities of light components of the measuring light separated by the spectroscopic unit are measured in parallel.

8. A film deposition method comprising:
an optical measurement step of measuring the light intensities of a plurality of measuring light beams having different wavelengths that are transmitted or reflected by a film during deposition;
a phase estimating step of calculating the phase of a point corresponding to a desired film thickness for each of the measuring wavelengths based on the relationship between expected periodic change in the light intensity of the corresponding measuring light beam until the desired film thickness is reached, and the phase corresponding to the periodic change, and calculating the degree of phase advance by comparing the periodic change and the changes in the light intensity of the measuring light beams monitored in the optical measurement step, the degree of phase advance representing the ratio of the phase of a point corresponding to the thickness of the film during deposition to the phase of the point corresponding to the desired film thickness; and
a deposition control step of comprehensively determining a deposition end point based on the degrees of phase advance for all the wavelengths and of completing the film deposition at the deposition end point.

9. A film deposition method according to claim 8, wherein phase differences between the phases of the points corresponding to the desired film thickness for the measuring wavelengths and the phases of the points corresponding to the thickness of the film being deposited are calculated, and the deposition end point is calculated as a point at which the square sum of the phase differences of all the measuring wavelengths shows the minimum value.

10. A film deposition method according to claim 9, wherein, when the film has a plurality of layers, the degree of phase advance is calculated in the phase estimating step by comparing the periodic change expected from the layout of the layers and the change in the light intensity monitored in the optical measurement step.

11. An optical filter made of a multilayer thin film deposited by a film deposition apparatus, wherein the optical-thin-film deposition apparatus comprises:
an optical measurement unit for measuring the light intensities of a plurality of measuring light beams having different wavelengths that are transmitted or reflected by a film during deposition;
a phase estimating unit for calculating the phase of a point corresponding to a desired film thickness for each of the measuring wavelengths based on the relationship between the expected periodic change in the light intensity of the corresponding measuring light beam until the desired film thickness is reached, and the phase corresponding to the periodic change, and calculating the degree of phase advance by comparing the periodic change and the change in the light intensity of the measuring light beam monitored by the optical measurement unit, the degrees of phase advance representing the ratio of the phase of a point corresponding to the thickness of the film during deposition to the phase of the point corresponding to the desired film thickness; and
a deposition control unit for comprehensively determining a deposition end point based on the degrees of phase advance for all the wavelengths and for completing the film deposition at the deposition end point.

12. An optical filter made of a multilayer thin film deposited by a film deposition method, wherein the optical-thin-film deposition method comprises:
an optical measurement step of measuring the light intensities of a plurality of measuring light beams having different wavelengths that are transmitted or reflected by a film during deposition;
a phase estimating step of calculating the phase of a point corresponding to a desired film thickness for each of the measuring wavelengths based on the relationship between the expected periodic change in the light intensity of the corresponding measuring light beam until the desired film thickness is reached, and the phase corresponding to the periodic change, and calculating the degree of phase advance by comparing the periodic change and the change in the light intensity of the measuring light beam monitored in the optical measurement step, the degree of phase advance representing the ratio of the phase of a point corresponding to the thickness of the film during deposition to the phase of the point corresponding to the desired film thickness; and
a deposition control step of comprehensively determining a deposition end point based on the degrees of phase advance for all the wavelengths and of completing the film deposition at the deposition end point.

13. A film deposition apparatus for controlling the deposition of a thin film on a substrate, the apparatus comprising:
an optical measurement unit configured to measure the intensities of at least two measuring light beams reflected from or transmitted through a film deposited on the substrate, each of the at least two light beams having different wavelengths and an intensity that varies as a periodic function of the thickness of the film;
a phase estimating section configured to determine, for each of the measuring light beams, a target phase corresponding to the desired thickness of the film and a measured phase corresponding to the thickness of the deposited film based on the intensities measured; and
a deposition control unit configured to control the deposition so that deposition is terminated in response to a signal based on a comparison between the measured phase and target phase for each of the measuring light beams.

14. The film deposition apparatus as recited in claim 13, wherein the comparison between the measured phase and target phase includes finding a phase difference between the measured and target phases for each wavelength of the at least two measuring light beams.

15. The film deposition apparatus as recited in claim 14, wherein the comparison further includes summing, for each of a plurality of sampling times, the square of the phase difference for each wavelength of the at least two measuring light beams.

16. The film deposition apparatus as recited in claim 13, wherein the optical measurement unit includes a combination of a wavelength-tunable light source and a light-intensity detecting unit, and sequentially detects the phases of the different measuring light beams.

17. The film deposition apparatus as recited in claim 13, wherein the optical measurement unit includes at least two light sources and a light-intensity detecting unit configured to detect in parallel the phases of the different measuring light beams.
